(19) United States
(12) Patent Application Publication
(10) Pub. No.: US 2015/0136867 A1
(43) Pub. Date: May 21, 2015

(54) Induction Charging Nozzle Assembly and Method of Its Use

(71) Applicant: The State of Israel, Ministry of Agriculture & Rural Development, Agricultural Research, Beit Dagan (IL)

(72) Inventors: Beni Ronen, Raanana (IL); Keisar Ohaliav, Rishon Lezion (IL); Shmuel Ganmor, Gedera (IL)

(21) Appl. No.: 14/399,173

(22) PCT Filed: May 7, 2013
(86) PCT No.: PCT/IB2013/053650

§ 371 Date: Nov. 6, 2014

Related U.S. Application Data
(60) Provisional application No. 61/688,088, filed on May 8, 2012.

(51) Int. Cl. B05B 5/043; B05B 15/02; B05B 1/04; B05B 5/053

(52) U.S. Cl. CPC B05B 5/043; B05B 5/0533; B05B 15/0208; B05B 1/04
USPC 239/3; 239/690.1

(57) ABSTRACT

An induction charging nozzle assembly includes two branches of one or two electrodes, a nozzle and a power supply. The nozzle is positioned to spray an atomized spray of a liquid between parallel portions of the electrode branches. The power supply applies an electrical potential to the electrode(s) relative to the (grounded) liquid so that the liquid acquires an electrical charge when sprayed from the nozzle. Preferably, the nozzle is a hydraulic flat fan nozzle. The atomized spray preferably has a volume mean diameter between 80 microns and 140 microns and a charge-to-mass ratio of at least 0.8 mC/kg.

### FIELD AND BACKGROUND OF THE INVENTION

The present invention relates to a nozzle assembly for agricultural use and, more particularly, to an induction charging nozzle assembly that preferably is based on an unmodified conventional hydraulic flat fan nozzle.

Uniform deposition and application of sufficient amounts of active material are very important when applying low-toxicity pesticides to crops (S. Gan-Mor et al., Improved uniformity of spray deposition in a dense plant canopy: methods and equipment, Phytoparasitica 24(1):57-67 (1996)). The importance of this high-quality coverage increases as regulations regarding pesticide residues become stricter and consumer demand for clean products becomes stronger. Currently, the use of hydraulic pressure to break the sprayed liquid into small droplets is the most commonly used technique for generating droplets in agricultural spraying; this technique uses hydraulic pressure on a liquid that flows thorough a metal or ceramic orifice to produce the spray. Introducing air streams to assist in transporting the droplets towards the target generally improves the deposition (Gan-Mor et al., 1996). The process can be further improved by introduction of short-range electrostatic forces when the droplets approach the target.

The use of electrostatic charging in this manner is very common in industrial processes such as liquid-spray painting, and the advantage of electrostatics is enhanced when high charge-to-mass ratios are achieved. When appropriate charging levels are applied in agricultural spraying, the coverage can be very uniform and large amounts of material can be deposited, especially on hard to reach areas such as the undersides of leaves on the lower parts of plants (S. E. Law, Agricultural electrostatic spray application: a review of significant research and development during the 20th century, Journal of Electrostatics 51: 25-42 (2001)). In contrast, if the charge level is poor no coverage improvement is achieved. Therefore it is important to be sure of obtaining considerable charge level and improvements of deposition when acquiring and using a commercially available electrostatic sprayer. Agricultural sprayers that use electrostatic charging in addition to air assisted spraying and achieve average of 150% improvement in spray deposit density, are offered commercially by ESS Inc., Watkinsville, Ga., USA. The ESS nozzles provide droplets smaller than 50 μm Volume Mean Diameter (VMD).

It is important to note that the producers of conventional hydraulic nozzles recommend the use of droplet sizes of more than 90 um VMD and to avoid the use of very small droplets, because of the possibility that massive drift might occur because of the long settling time of such droplets. For similar reasons, some jurisdictions prohibit droplets smaller than 90 um VMD. The use of electrostatic charging in pesticide spraying on agricultural targets is rare, for a variety of reasons.

It would be highly advantageous to have an induction charging nozzle assembly, for agricultural use, that is based on a conventional hydraulic nozzle, possibly with air assistance. Preferably, the induction charging nozzle assembly would provide charge-to-mass ratios of at least 0.8 mC/kg.

### SUMMARY OF THE INVENTION

According to the present invention there is provided an induction charging nozzle assembly including: (a) an electrode including two branches; (b) a nozzle positioned relative to the electrode so as to spray an atomized spray of a liquid between the branches, the branches being substantially parallel at least along the portions thereof between which the spray passes; and (c) a power supply for applying an electric potential to the electrode relative to the liquid so that the liquid acquires an electrical charge when sprayed from the nozzle.

According to the present invention there is provided a method of spraying a liquid, including the steps of (a) forcing the liquid through an orifice of a nozzle, thereby creating an atomized spray; (b) directing the atomized spray between two substantially parallel branches of an electrode; and (c) electrically charging the atomized spray by applying an electric potential to the electrode relative to the liquid.

According to the present invention there is provided an induction charging nozzle assembly including: (a) an electrode; (b) a nozzle for spraying a liquid; (c) a power supply for applying an electric potential to the electrode relative to the liquid; (d) at least one electrically insulating supporting member for mounting the electrode relative to the nozzle so that the electric potential induces an electrostatic charge on an atomized spray of the liquid that is sprayed via the nozzle; and (e) a mechanism for keeping dry at least a portion of the electrode and at least a portion of each supporting member while the liquid is sprayed via the nozzle.

According to the present invention there is provided a method of spraying a liquid, including the steps of: (a) forcing the liquid through an orifice of a nozzle, thereby creating an atomized spray of the liquid; (b) applying an electric potential to an electrode relative to the liquid; (c) mounting the electrode relative to the nozzle, using at least one electrically insulating supporting member, so that the electric potential induces an electrostatic charge on the atomized spray; and (d) while the liquid is forced through the orifice, keeping dry at least a portion of the electrode and at least a portion of each supporting member.

A first basic induction charging nozzle assembly of the present invention includes an electrode with two branches (or two electrodes with one or more branches each), a nozzle and a power supply. The nozzle is positioned relative to the electrode(s) so as to spray an atomized spray of a liquid between the two branches, or between two of the branches. At least the portions of the two branches between which the spray passes are substantially parallel to each other. The power supply applies an electric potential to the electrode(s) relative to the liquid so that the liquid acquired an electrical charge when sprayed from the nozzle.

Preferably, the gap between the substantially parallel at least portions of the two branches between which the atomized spray passes is between about 20 mm and about 40 mm.

Preferably, the distance between the orifice of the nozzle and a surface defined by the parallel at least portions of the two branches between which the atomized spray passes is between about 10 mm and about 30 mm, and most preferably between about 16 mm and about 22 mm.

Preferably, the induction charging nozzle assembly also includes an air blower for directing a stream of air onto the electrode branches between which the atomized spray passes. The air blower is separate from the nozzle and most preferably the nozzle is outside the air blower. Also most preferably, the induction charging nozzle assembly also includes one or more electrically insulating supporting members for mounting the electrode(s) in the correct position relative to the nozzle. The air blower also directs the stream of air onto the supporting member(s).

Preferably, the nozzle is a hydraulic nozzle, i.e., a nozzle that uses the kinetic energy of the liquid that is forced therethrough to atomize the liquid, without air assistance. Most preferably, the nozzle is a flat fan hydraulic nozzle that is oriented relative to the electrode(s) so that the shape of the atomized spray that passes between the two electrode branches is a flat fan whose plane is substantially parallel to the two electrode branches.

Preferably, the induction charging nozzle assembly includes a substantially one-dimensional (linear or curved) array of a plurality of the nozzles. The array is substantially parallel to the electrode branches between which the nozzles' atomized sprays pass: each nozzle is positioned relative to the electrode(s) so as to spray its respective atomized liquid spray between the two electrode branches. Most preferably, the nozzles are spaced at least about 90 mm apart.

Preferably, the absolute value of the electric potential that is applied to the electrode(s) relative to the liquid is at least about 7 kV.

In a first basic method of the present invention for spraying a liquid, the liquid is forced through the orifice of a nozzle, thereby creating an atomized spray. The atomized spray is directed between two substantially parallel branches of one or more electrodes. The atomized spray is charged electrically by applying an electric potential to the electrode(s) relative to the liquid.

Preferably, the volume mean diameter of the atomized spray is between about 80 microns and about 140 microns.

Preferably, the electric potential is between about 8 kV and about 18 kV.

Preferably, the method also includes directing a stream of air onto the electrode branches to keep the electrode branches dry. Preferably, the speed of the air stream is between about 10 m/sec and about 90 m/sec. Most preferably, the speed of the air stream is between about 40 m/sec and about 80 m/sec. Also most preferably, the electrode(s) is/are mounted relative to the nozzle using one or more electrically insulating supporting members, and the air stream also is directed onto the supporting member(s) to keep dry at least a portion of each supporting member. Also most preferably, the air stream is directed onto the atomized spray in a manner that helps propel the atomized spray towards a target. In the present context, the target typically is an agricultural target and the liquid that is sprayed typically is an agricultural chemical such as a pesticide or a fungicide.

Preferably, the electrical charging of the atomized spray produces an electrically charged atomized spray that has a charge-to-mass ration of at least about 0.8 mC/kg.

A second basic induction charging nozzle assembly of the present invention includes an electrode, a nozzle for spraying a liquid, and a power supply for applying an electric potential to the electrode relative to the liquid. The electrode is mounted relative to the nozzle, using one or more electrically insulating supporting members, so that the electric potential induces an electrostatic charge on an atomized spray of the liquid that is sprayed via the nozzle. The assembly also includes a mechanism for keeping dry at least a portion of the electrode and at least a portion of each supporting member while the liquid is being sprayed via the nozzle. The preferred such mechanism is an air blower for directing a stream of air onto the electrode and the supporting member(s).

In a second basic method of the present invention for spraying a liquid, the liquid is forced through the orifice of a nozzle, thereby creating an atomized spray. An electric potential is applied to an electrode relative to the liquid. One or more electrically insulating supporting members are used to mount the electrode relative to the nozzle so that the electric potential induces an electrostatic charge on the atomized spray. While the liquid is being forced through the orifice to create the atomized spray, at least a portion of the electrode and at least a portion of each supporting member are kept dry, preferably by directing a stream of air onto the electrode and onto the supporting member(s).

### BRIEF DESCRIPTION OF THE DRAWINGS

Various embodiments are herein described, by way of example only, with reference to the accompanying drawings, wherein:

FIG. 1 is a perspective view of an induction charging nozzle assembly of the present invention with a single nozzle;

FIG. 2 illustrates two geometric parameters of the induction charging nozzle assembly;

FIG. 3 illustrates three more features of the present invention;

FIG. 4 is a partial illustration of an induction charging nozzle assembly with three nozzles;

FIG. 5 shows the relationship between the parameters L, ΔE and v as determined experimentally;

FIG. 6 is a table of statistics for FIG. 5;

FIG. 7 shows the results of spray deposition on water-sensitive papers.

### DESCRIPTION OF THE PREFERRED EMBODIMENTS

The principles and operation of an induction charging nozzle assembly according to the present invention may be better understood with reference to the drawings and the accompanying description.

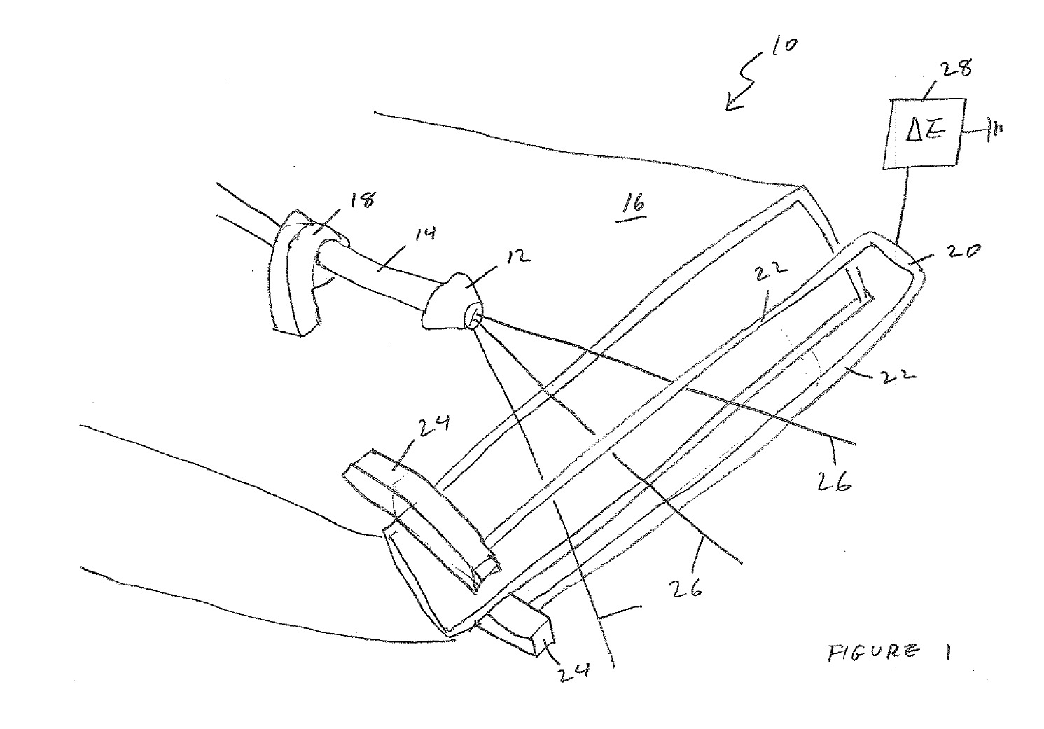

Referring now to the drawings, FIG. 1 is a perspective view of an induction charging nozzle assembly 10 of the present invention. Assembly 10 is based on an outlet 16 of an air blower, to which are attached a conventional hydraulic nozzle 12 and an electrode 20. Nozzle 12 is connected by a pipe 14 to an electrically grounded reservoir (not shown) of a liquid such as a pesticide or a fungicide, via a pump (also not shown) that pumps the liquid at high pressure through nozzle 12 to create a flat-fan-shaped atomized spray 26 of an aerosol of the liquid. Also attached to outlet 16 by electrically insulating support members 24 is a U-shaped electrode 20 made of a good electrical conductor such as stainless steel. Although support members 24 are shown in FIG. 1 as being attached to outlet 16, such support members may be attached anywhere that is convenient in an induction charging nozzle assembly, for example on a common housing that encloses both the nozzle and the air blower outlet, as long as support members 24 are kept dry by the air stream from the air blower outlet. The portion of pipe 14 close to nozzle 12 is rigid, and is supported on outlet 16 by a bracket that is arranged to point nozzle 12 so that spray 26 passes between the two branches 22 of electrode 20. Support members 24 are shaped to support electrode 20 relative to outlet 16 so that the air stream that emerges from outlet 16 impinges on both electrode 20 and at least the portions of support members 24 that are closest to electrode 20 and keeps both electrode 20 and those portions of support members 24 dry. Electrode 20 is connected to a conventional DC power supply that places electrode 20 at a high voltage, relative to ground, so that an electrical charge is induced on the droplets of spray 26. This conventional DC power supply is represented symbolically in FIG. 1 at 28.

The voltage difference imposed by DC power supply 28 between electrode 20 and ground is denoted in FIG. 1 as “ΔE”. If ΔE>0 a positive electric potential is imposed on electrode 20 and a negative charge is induced on the droplets of spray 26. If ΔE<0 a negative electric potential is imposed on electrode 20 and a positive charge is induced on the droplets of spray 26. The values of charge-to-mass ratio that are given herein are absolute values.

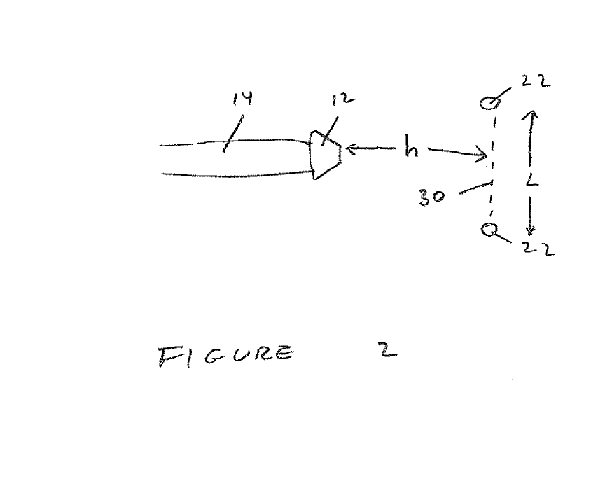

ΔE is just one of the parameters involved in the design of assembly 10. FIG. 2 shows two more such parameters: the separation L of branches 22 and the distance h between the tip of nozzle 12 and the plane 30 defined by branches 22. The fourth parameter of interest is the speed of the air that exits from blower outlet 16, as the air passes the tip of nozzle 12. This speed is denoted herein by “v”. One of the purposes of the air that is blown from outlet 16 onto branches 22 and support members 24 is to dry off the droplets of spray 26 that tend to accumulate on branches 22 and support members 24, to keep these droplets from forming an electrically conductive path between electrode 20 and the rest of assembly 10. The flow of air from outlet 16 past branches 22 and support members 24 must be sufficient in both speed and volume to keep branches 22 and at least the portions of support members 24 closest to branches 22 substantially dry.

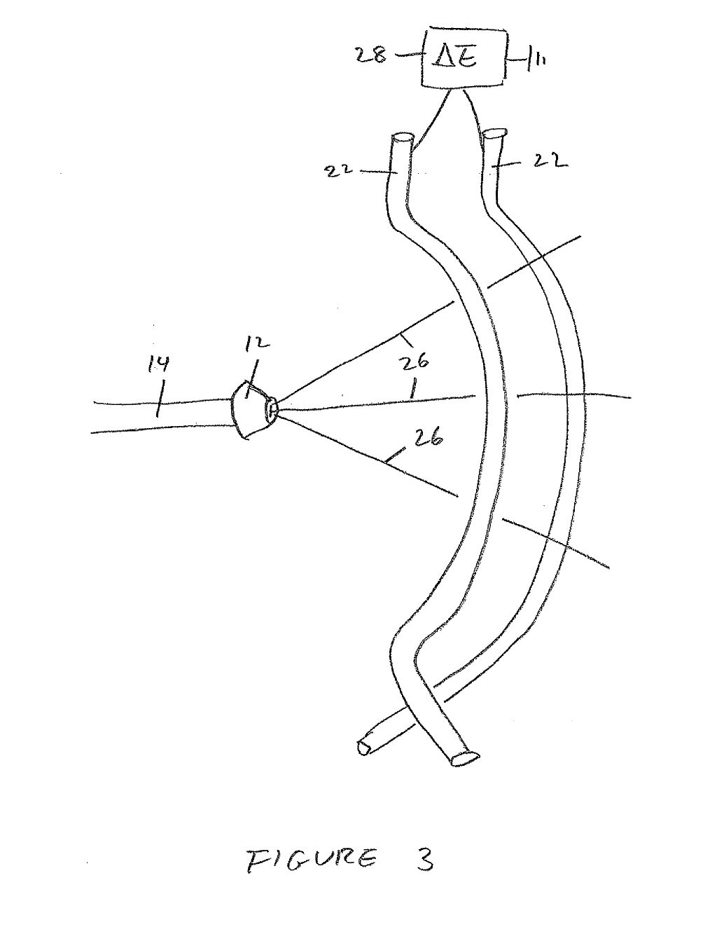

FIG. 3 illustrates three more features of the present invention:

1. Branches 22 need not be parallel along their entire lengths. Branches 22 need to be parallel only along the portion of the gap between them that is traversed by spray 26.

2. Branches 22 need not be branches of the same electrode 20. Each branch 22 can be an electrode 20 in its own right, as long as both branches 22 are charged to the same potential ΔE relative to ground. Of course, if each branch 22 is part or all of a different electrode 20, that electrode 20 must be attached to the rest of assembly 10 by its own set of one or more insulating supporting members 22 (not shown in FIG. 3).

3. Branches 22 can be either straight or curved.

FIG. 4 is a partial illustration of another induction charging nozzle assembly 10′ that includes three nozzles 12, all of which spray their sprays 26 between two branches 22 of the same electrode 20. As in FIG. 3, air blower outlet 16, brackets 18 and supporting members 24 are not shown in FIG. 4 for simplicity of illustration.

A laboratory testing system was devised to determine optimal values of the system design parameters ΔE, L, h and v. Preliminary tests showed that induction charging of sprays 26 generated with flat-fan nozzles 12 was superior to all other test setups. Two parallel charging electrode branches 22 were found to provide relatively high charging levels, and trials to reduce the setup size led to preference for 80-degree nozzles 12. Laboratory limitations such as maximal drift and liquid handling led to preference of low-flow-rate nozzles 12. Therefore, flat-fan nozzles model TP8001 (by Teejet Technologies Inc. of Wheaton, Ill. USA) and yellow Albuz AX18002 nozzle (by CoorsTek, Inc., Evreux, France) were selected. The preliminary tests also showed that the ambient air speed next to the nozzle edge had a, positive influence on the charge levels.

The dependent parameter that was monitored was the current, I, produced by the laboratory setup.

The charge-to mass ratio was easily determined by dividing the current by the liquid flow rate. The measured flow rates at a pressure of 4 bar were 0.55 and 0.7 l/min for the Teed TP8001 nozzle and the yellow Albuz AX18002, respectively. A variable-speed radial blower provided ambient air velocities ranging from 5 to 65 m/min at the blower outlet, which was rectangular, measuring 5×24 cm, and located 10.0 cm from the nozzle tip. A metal mesh screen made of 0.5 mm wires with 2×2 mm square openings was positioned 24 cm from the nozzle tip, and was used for collecting the electric charges from the droplets in the air jet. The screen was placed 3.0 cm above a plastic bowl that served to collect the spray fluid, which subsequently was drained. The bowl was insulated, and the current, I, from the screen and the bowl was monitored with a UT 58 meter (Uni-Trend Group Ltd., Hong Kong, China) which, after some modification and calibration provided an accuracy of ±1 μA. With every test setup five repetition of the reading were sampled.

Several parameters influence the current on the mesh, which was defined as the dependent variable. In the light of the difficulty of simultaneously conducting experiments, analyzing the results, and presenting the findings with respect to all the above independent parameters, preliminary tests were conducted to determine which parameters had a weak influence, and to set their optimal values as unvarying parameter. The first set of tests addressed the influence of the distance between the electrode branches and the nozzles (the parameter h). The electrode potential, ΔE was 20 kV and the air speed, v, was 60 m/s. Table 1 shows, for two spacings between the electrode branches (the dimension L), that the distance between the electrode branches and the nozzles had a weak influence on the current, I, which was delivered by the spray cloud. For electrode branch to nozzle distances between 16 and 20 mm maximal currents were 13 to 14 μA, for the two electrode branch spacings shown in Table 1. Therefore, a distance of 19 mm between the electrode branches and the nozzle was selected for the subsequent tests. This selection enabled the following simpler analysis.

TABLE 1

| h, mm | | | | | | | | | | L, |
|---|---|---|---|---|---|---|---|---|---|---|
| 14 | 16 | 18 | 19 | 20 | 22 | 24 | 26 | 28 | 30 | mm |
| 13 | 13 | 13 | 13.5 | 13.5 | 13.5 | 12.5 | 12.5 | 12 | 11.5 | 36 |
| 13 | 14 | 13.5 | 13.5 | 13 | 11.5 | 11.5 | 10.5 | 9.5 | 8.5 | 29 |

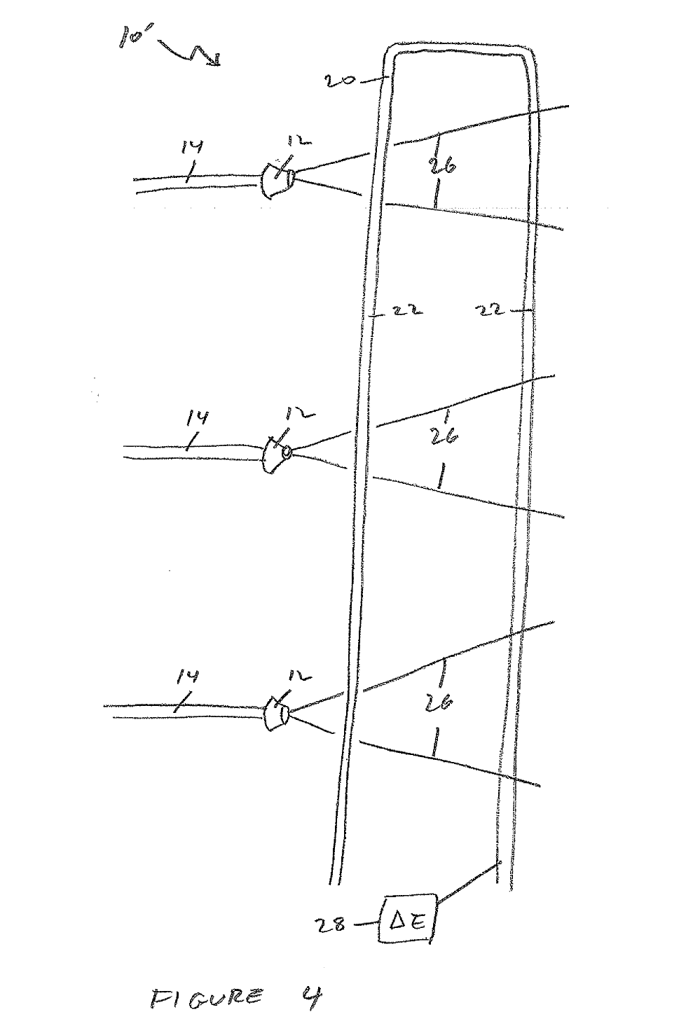

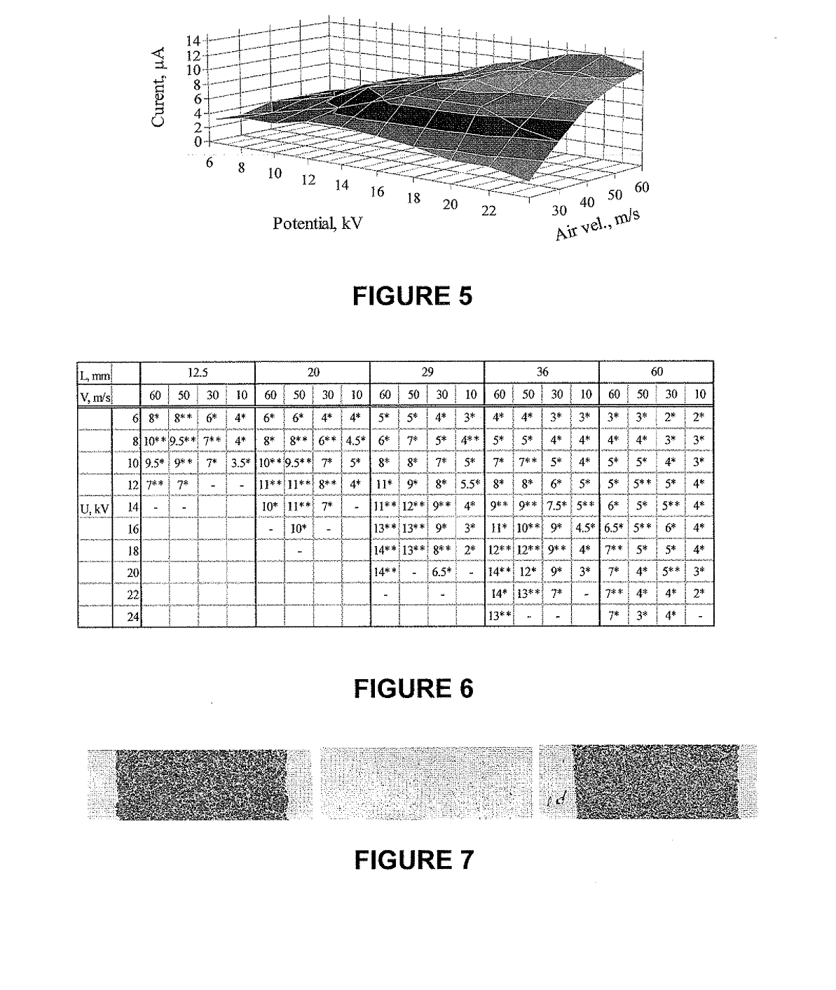

The following parameters were found to exert substantial influence on the current delivered by the charged cloud: the electrodes spacing, L; the electrode potential, ΔE; and the air speed, v. FIG. 5 shows results for L=29 mm. The results presented in FIG. 5 show that, generally, an increase in air speed facilitated an increase in the current delivered by the spray cloud. It also shows that as the electrode potential increased the current reached a peak value and then decreased. However, when a higher air speed was used the electrode potential could be increased to achieve a slightly higher peak current. Thus, it was possible to increase the current by simultaneous and coordinated increase of both the air speed and the potential, until the blower air speed limit was reached. An air speed of 70 m/s at the blower outlet is not unusual for commercial air-assisted spraying equipment, and for certain sprayers higher air velocities are used. In the present laboratory setup, where proper measurement necessitated the collection of all the spray into a collection container, increasing the air speed above 60 m/s caused massive spray drift and prevented collection of all the spray and spray charge. Therefore, the present measurements were limited to a maximum air speed of 60 m/s. FIGS. 5 and 6 show that a current of 14 μA per nozzle was obtained for the easily achieved electrode potentials of 18 to 22 kV. In the table of FIG. 6, “*” denotes a standard error of 0.5 to 0.8 μA and “**” denotes a standard error of 0.9 to 1.1 μA. When the charge-to-mass ratio was calculated for low-flow-rate nozzles, such as the 80-degrees flat-fan type TeeJet TP8001 or yellow Albuz AX18002, for a flow rate of 0.55 l/min, a charge-to-mass ratio of 1.63 mC/kg was obtained.

A field system was developed, based on the results obtained with the laboratory setup. Because several nozzles were needed in the field system, the influence of the proximity between the nozzles was evaluated. Generally, the current delivered by each nozzle was reduced when two or more nozzles were placed next to each other and the induction charging technology of the present invention was used. The current decreased as the distance between adjacent nozzles decreased, however, since the current reduction did not vary linearly with this distance, an optimal distance of 90 mm between the centers of adjacent nozzles was selected.

An electrostatic charging system was designed and constructed for a vineyard sprayer obtained from Degania Sprayers Inc. (Degania, Israel). The geometry of the charging electrodes was set in accordance with the optimal setup found in the laboratory, and the charging potential was set at 10.5 kV. The hydraulic pressure was set at 10 bar as an optimal value, in the light of the laboratory findings and the manufacturer's recommendations. The air velocity at the outlets was 68 m/s and the air blower outlet dimensions were 165×42 mm. Insulating the electrodes was of major importance: whereas in the laboratory the electrodes were hooked to an insulated gauge, the setup of the field unit was rather complicated. A technique for insulating the electrodes was incorporated using continuous drying process of blowing dry air jets onto the plastic electrode holders. This continuous drying of the plastic electrode holders is believed to be an important factor in obtaining the requisite high level of electrostatic charging.

Three sets of measurements were taken: (a) Current measurements on a 100×100 cm mesh screen located 1.2 m from the blower outlet. (b) Simulated tests of deposition on hard-to-reach areas were conducted by using a grounded metal cylinder measuring 5 cm in diameter and 14 cm in length as a target. Water-sensitive paper was attached to the front and to the back of the cylinder, to provide a simulated assessment of the influence of the charge, as described by Law (2001). The cylinder was connected to a 100 cm metal bar and moved across the stream at approximately 0.8 m/s, with the sprayer stationary. (c) Deposition on grape clusters and leaves by a vineyard sprayer was assessed by using a fluorescent tracer for coverage evaluation, according to Maclntyre-Allena et al., Confirmation by fluorescent tracer of coverage of onion leaves for control of onion thrips using selected nozzles, surfactants and spray volumes, Crop Protection 26:1625-1633 (2007), with only the top outlet of one side equipped with the electrostatic system and operated during the test.

Current measurements on a (1×1) in screen located 1.2 m from the air blower outlet showed a current of up to 12 μA for two yellow Albuz AX18002 flat fan nozzles. This current was almost doubled, and reached a level of 22 μA, when the screen was located 70 cm from the air blower outlet.

The results of a simulation test of deposition on hard-to-reach areas, which involved a target in the form of a grounded metal cylinder measuring (50×140) mm in diameter×length with water-sensitive paper attached to its front and back, are shown in FIG. 7. The spraying was performed with the vineyard sprayer that is described above. Without charging, spraying for approximately 0.7 s resulted in an average of 480 droplets per cm² on the surface facing the oncoming spray (FIG. 7; left). During the same time the amount of spray deposited on the surface behind the cylinder was insufficient (FIG. 7; middle) with an average of 23 droplets/cm². However, when the above-mentioned optimal charging was applied for the same length of time an adequate amount of spray was deposited on the surface behind the cylinder, i.e., an average of 370 droplets/cm² (FIG. 7; right). It is important to note that droplet counting for deposition density greater than 300 droplets/cm² and droplet sizes greater than 100 μm, lacks accuracy, because many droplets touch each other or even overlap. Charging also increases the amount deposited on the surface facing the oncoming spray, but since the there was already in excess, this addition is much less important than that on the hard-to-reach area.

Distribution of spray deposit on grape clusters achieved by spraying with a vineyard sprayer was evaluated by using a fluorescent tracer, with only the top outlet of one side operative and equipped with the field electrostatic system. The deposit distributions on the rear of the cluster for spraying without and with charging (numbers of droplets per cm²) are shown in Tables 3 (uncharged spraying) and 4 (charged spraying), respectively. Table 5 shows the results for the underside of leaves, without and with charging.

TABLE 3

| SD | Average | Grape III | Grape II | Grape I | Cluster |
|---|---|---|---|---|---|
| | 20 | 30 | 10 | 20 | 1 |
| | 37 | 10 | 70 | 30 | 2 |
| | 37 | 80 | 0 | 30 | 3 |
| | 13 | 10 | 30 | 0 | 4 |
| | 47 | 20 | 0 | 120 | 5 |
| | 43 | 50 | 0 | 80 | 6 |
| 13.2 | 33 | | | | Total |

TABLE 4

| SD | Average | Grape III | Grape II | Grape I | Cluster |
|---|---|---|---|---|---|
| | 127 | 70 | 110 | 200 | 7 |
| | 167 | 200 | 100 | 200 | 8 |
| | 313 | 260 | 290 | 390 | 9 |
| | 123 | 110 | 120 | 140 | 10 |
| | 203 | 200 | 230 | 180 | 11 |
| | 193 | 290 | 160 | 130 | 12 |
| 69.8 | 188 | | | | Total |

TABLE 5

| | Droplets density, | |
|---|---|---|
| SD | No./cm² | Treatment |
| 92 | 116 | Uncharged |
| 98.2 | 247 | Charged |
| | 2.1 | Improvement ratio |

Compared with uncharged spraying, the use of charged spraying provided more than five times as many droplets per unit area on the rear of grape clusters and more than twice as many droplets per unit area on the undersides of leaves. The statistical differences are significant for both the rear of grape clusters and the undersides of leaves. The uncharged deposition on the front of clusters was already in excess; therefore, significant improvement in this area as a result of using charged spraying was neither needed nor evident.

The air speed seems to be the most important independent parameter for design purposes: the blown air provides continuous drying of the electrode holders, optimal air speed facilitates reduction of the distance between the induction electrode and the nozzle outlet, and optimal air speed minimizes charge leakage from the spray cloud to the induction electrode. This charge leakage can be determined by measuring the potential drop on the charging electrode when the liquid flow is opened, since the resistors on the high-voltage line are of known value. Since the influence of charge leakage is already implicit in the above results it has not been analyzed separately. Straightforward measurements showed that increasing the flow rate by raising the pressure or by using nozzles with higher flow rates increased the charging level. Additional measurements showed that the spacing between two adjacent nozzles has strong influence, and that reduction of this spacing considerably reduce the charge level per nozzle. This means that a design with a smaller number of nozzles of higher flow rate provides higher charging levels than a larger number of nozzles of lower flow rate.

The charge-to-mass ratios provided by the present invention are approximately three times higher than the highest charge-to-mass ratio obtained conventionally, and the benefit was clearly demonstrated in the simulation test by placing water-sensitive papers on the rear of a cylinder, as shown in FIG. 7.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. An induction charging nozzle assembly comprising:
(a) an electrode including two branches;
(b) a nozzle positioned relative to said electrode so as to spray an atomized spray of a liquid between said branches, said branches being substantially parallel at least along said portions thereof between which said spray passes; and
(c) a power supply for applying an electric potential to said electrode relative to said liquid so that said liquid acquires an electrical charge when sprayed from said nozzle.

2. The induction charging nozzle assembly of claim 1, wherein a gap between said branches in said substantially parallel portion of said branches is between about 20 mm and about 40 mm.

3. The induction charging nozzle assembly of claim 1, wherein a distance between an orifice of said nozzle and a surface defined by said branches in said substantially parallel portion of said branches is between about 10 mm and about 30 mm.

4. The induction charging nozzle assembly of claim 3, wherein said distance is between about 16 mm and about 22 mm.

5. The induction charging nozzle assembly of claim 1, further comprising:
(d) an air blower, separate from said nozzle, for directing a stream of air onto said branches.

6. The induction charging nozzle assembly of claim 5, wherein said nozzle is outside of said air blower.

7. The induction charging nozzle assembly of claim 5, further comprising:
(e) at least one electrically insulating supporting member for mounting said electrode in said position relative to said nozzle;
and wherein said air blower also directs said stream of air onto said at least one supporting member.

8. The induction charging nozzle assembly of claim 1, wherein said nozzle is a hydraulic nozzle.

9. The induction charging nozzle assembly of claim 8, wherein said hydraulic nozzle is a flat fan hydraulic nozzle that is oriented relative to said electrode so as to spray a flat fan of said atomized spray substantially parallel to said branches.

10. The induction charging nozzle assembly of claim 1, comprising a substantially one-dimensional array of a plurality of said nozzles, said array being substantially parallel to said branches, so that each said nozzle is positioned relative to said electrode so as to spray a respective atomized spray of a liquid between said branches.

11. The induction charging nozzle of claim 10, wherein said nozzles are spaced at least about 90 mm apart.

12. The induction charging nozzle of claim 1, wherein said electric potential is at least about 7 kV.

13. A method of spraying a liquid, comprising the steps of:
(a) forcing the liquid through an orifice of a nozzle, thereby creating an atomized spray;
(b) directing said atomized spray between two substantially parallel branches of an electrode; and
(c) electrically charging said atomized spray by applying an electric potential to said electrode relative to said liquid.

14. The method of claim 13, wherein a volume mean diameter of said atomized spray is between about 80 microns and about 140 microns.

15. The method of claim 13, wherein said electric potential is between about 8 kV and about 18 kV.

16. The method of claim 13, further comprising the step of:
(d) directing a stream of air onto said branches to keep said branches dry.

17. The method of claim 16, wherein said stream of air has a speed of between about 10 m/sec and about 90 m/sec.

18. The method of claim 17, wherein said stream of air has a speed of between about 40 m/sec and about 80 m/sec.

19. The method of claim 16, wherein said electrode is mounted relative to said nozzle using at least one electrically insulating supporting member and wherein said stream of air also is directed onto said at least one supporting member to keep dry at least a portion of each said at least one supporting member.

20. The method of claim 16, wherein said stream of air is directed onto said atomized spray so as to urge said atomized spray towards a target.

21. The method of claim 13, wherein said electrically charging produces an electrically charged atomized spray having a charge-to-mass ratio of at least about 0.8 mC/kg.

22. An induction charging nozzle assembly comprising:
(a) an electrode;
(b) a nozzle for spraying a liquid;
(c) a power supply for applying an electric potential to said electrode relative to said liquid;
(d) at least one electrically insulating supporting member for mounting said electrode relative to said nozzle so that said electric potential induces an electrostatic charge on an atomized spray of said liquid that is sprayed via said nozzle; and
(e) a mechanism for keeping dry at least a portion of said electrode and at least a portion of each said supporting member while said liquid is sprayed via said nozzle.

23. The induction charging nozzle assembly of claim 22, wherein said mechanism includes an air blower for directing a stream of air onto said electrode and said at least one supporting member.

24. A method of spraying a liquid, comprising the steps of:
(a) forcing the liquid through an orifice of a nozzle, thereby creating an atomized spray of the liquid;
(b) applying an electric potential to an electrode relative to said liquid;
(c) mounting said electrode relative to said nozzle, using at least one electrically insulating supporting member, so that said electric potential induces an electrostatic charge on said atomized spray; and
(d) while the liquid is forced through said orifice, keeping dry at least a portion of said electrode and at least a portion of each said supporting member.

25. The method of claim 24, wherein said keeping dry is effected by directing a stream of air onto said electrode and onto said at least one supporting member.
